(19) United States
(12) Patent Application Publication
(10) Pub. No.: US 2020/0336684 A1
(43) Pub. Date: Oct. 22, 2020

(54) PATTERN CONFIGURABLE PIXEL CORRECTION

(71) Applicant: QUALCOMM Incorporated, San Diego, CA (US)

(72) Inventors: Jing Wang, Milpitas, CA (US); Shang-Chih Chuang, San Diego, CA (US); Xiaoyun Jiang, San Diego, CA (US)

(21) Appl. No.: 16/389,221

(22) Filed: Apr. 19, 2019

(51) Int. Cl. H04N 5/367; H04N 9/04

(52) U.S. Cl. CPC H04N 5/367; H04N 2209/045; H04N 9/04515

(57) ABSTRACT

Methods, systems, and devices for image processing are described. A device may capture image data based on a color filter array (CFA) associated with an image sensor. The image data may include a set of pixels. The device may determine a CFA pattern of the CFA and select a configuration appropriately. The configuration may include an indication of a first set of neighboring pixels for each pixel of the set of pixels to use to determine that a pixel is defective and a second set of neighboring pixels for each pixel of the set of pixels to use to correct the defective pixel. The device may determine that the pixel of the set of pixels is defective using the configuration, and correct the defective pixel using pixel values of the first set of neighboring pixels, or pixel values of the second set of neighboring pixels, or both.

### BACKGROUND

Consumer devices may be configured with image sensors for performing image processing related operations. The image sensors may be configured with a color filter array (CFA) to capture color information. When performing image processing related operations, image sensors may produce defect pixels which may degrade the quality of captured images. If defect pixels are not corrected before other image processing operations, image quality can be negatively impacted.

In addition to defect pixels, other examples of pixels to correct include phase detection (PD) pixels and PD autofocus (PDAF) pixels, which may be used in image sensors for autofocus operations. Some techniques use a pixel correction scheme that is particularly designed for a defined CFA pattern. To support more than one type of CFA pattern, however, the device has to be configured with multiple hardware resources for each CFA pattern, which may be an inefficient use of resources for the device. Improved techniques for pattern configurable pixel correction are desired.

### SUMMARY

The described techniques relate to improved methods, systems, devices, and apparatuses that support pattern configurable pixel correction. More specifically, the described techniques support image processing according to a pattern configurable pixel correction scheme for multiple different types of color filter array (CFA) patterns without added hardware cost to a device. A CFA may represent a pattern or mosaic of different color filters which may be placed over an image sensor. Exemplary types of CFA patterns include a Bayer CFA, an X-Trans, and a quad-color filter array (Q-CFA). The pattern configurable pixel correction scheme may use a set of configurable tables that may define one or more neighboring pixels relative to a target pixel location in a CFA pattern, as well as phase detection (PD) pixels and PD autofocus (PDAF) pixels locations in the CFA pattern in some examples. The pattern configurable pixel correction scheme may ignore determining PDAF pixel locations since these pixel locations are known. Thus, the PDAF pixels can be handled as known defect pixels in the CFA pattern. For example, PDAF may use paired masked (e.g., shielded) pixels on an image sensor to obtain phase differences, as pixel responses of PDAF pixels may differ from pixel responses of non-PDAF pixels (e.g., PDAF pixels may respond to light differently than non-PDAF pixels).

To determine one or more defect pixels (e.g., that are non-PDAF pixels), the pattern configurable pixel correction scheme may identify values, such as maximum and minimum values, among the neighboring pixels relative to the target pixel, and correct the defect target pixel using the values. Alternatively or additionally, the pattern configurable pixel correction scheme may use directional interpolation, for example using a gradient calculation, which may improve interpolation of pixels along edges of an image. A weighted average of the pixels in a direction may then be used for directional interpolation and the weight may be based on a table having a set of weight entries corresponding to different distances to a center (e.g., unless it is a PD pixel, then the weight may be null).

A method of image processing is described. The method may include capturing image data based on a CFA associated with an image sensor, the image data including a set of pixels, determining a CFA pattern of the CFA associated with the image sensor, selecting a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determining that the pixel of the set of pixels is defective using the configuration, and correcting the defective pixel using pixel values of the first set of neighboring pixels, or pixel values of the second set of neighboring pixels, or both.

An apparatus for image processing is described. The apparatus may include a processor, memory in electronic communication with the processor, and instructions stored in the memory. The instructions may be executable by the processor to cause the apparatus to capture image data based on a CFA associated with an image sensor, the image data including a set of pixels, determine a CFA pattern of the CFA associated with the image sensor, select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determine that the pixel of the set of pixels is defective using the configuration, and correct the defective pixel using pixel values of the first set of neighboring pixels, or pixel values of the second set of neighboring pixels, or both.

Another apparatus for image processing is described. The apparatus may include means for capturing image data based on a CFA associated with an image sensor, the image data including a set of pixels, determining a CFA pattern of the CFA associated with the image sensor, selecting a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determining that the pixel of the set of pixels is defective using the configuration, and correcting the defective pixel using pixel values of the first set of neighboring pixels, or pixel values of the second set of neighboring pixels, or both.

A non-transitory computer-readable medium storing code for image processing is described. The code may include instructions executable by a processor to capture image data based on a CFA associated with an image sensor, the image data including a set of pixels, determine a CFA pattern of the CFA associated with the image sensor, select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determine that the pixel of the set of pixels is defective using the configuration, and correct the defective pixel using pixel values of the first set of neighboring pixels, or pixel values of the second set of neighboring pixels, or both.

Some examples of the method, apparatuses, and non-transitory computer-readable medium described herein may further include operations, features, means, or instructions for determining that a set of phase detection pixels of the set of pixels in the CFA pattern may be defective pixels based on the image sensor, and correcting the set of phase detection pixels of the set of pixels using pixel values of the first set of neighboring pixels or pixel values of the second set of neighboring pixels, or both.

Some examples of the method, apparatuses, and non-transitory computer-readable medium described herein may further include operations, features, means, or instructions for determining a first pixel value of the pixel of the set of pixels, determining a second pixel value of each pixel of the first set of neighboring pixels, and comparing the first pixel value to the second pixel value. In some examples of the method, apparatuses, and non-transitory computer-readable medium described herein, determining that the pixel of the set of pixels may be defective may be based on the comparing.

In some examples of the method, apparatuses, and non-transitory computer-readable medium described herein, the pixel of the set of pixels may be a center pixel in the first set of neighboring pixels.

Some examples of the method, apparatuses, and non-transitory computer-readable medium described herein may further include operations, features, means, or instructions for identifying a maximum pixel value of the first set of neighboring pixels based on the pixel value of each pixel of the first set of neighboring pixels, determining that the pixel value of the pixel of the set of pixels may be greater than the maximum pixel value of the first set of neighboring pixels by a threshold pixel value, where the threshold pixel value may be configurable based on a set of tuning parameters including a weighting factor, the maximum pixel value, or a pixel offset value, or a combination thereof, and clamping the pixel value of the pixel of the set of pixels with the maximum pixel value. In some examples of the method, apparatuses, and non-transitory computer-readable medium described herein, correcting the defective pixel may be based on replacing the pixel value of the pixel of the set of pixels with the maximum pixel value.

Some examples of the method, apparatuses, and non-transitory computer-readable medium described herein may further include operations, features, means, or instructions for identifying a minimum pixel value of the first set of neighboring pixels based on the pixel value of each pixel of the first set of neighboring pixels, determining that the pixel value of the pixel of the set of pixels may be less than the minimum pixel value of the first set of neighboring pixels by a threshold pixel value, where the threshold pixel value may be configurable based on a set of tuning parameters including a weighting factor, the minimum pixel value, or a pixel offset value, or a combination thereof, and clamping the pixel value of the pixel of the set of pixels with the minimum pixel value. In some examples of the method, apparatuses, and non-transitory computer-readable medium described herein, where correcting the defective pixel may be based on replacing the pixel value of the pixel of the set of pixels with the minimum pixel value.

Some examples of the method, apparatuses, and non-transitory computer-readable medium described herein may further include operations, features, means, or instructions for determining multiple color gradients based on a kernel, where the kernel includes the pixel and the second set of neighboring pixels, where each color gradient of the multiple color gradients characterizes a color variation along a different direction. In some examples of the method, apparatuses, and non-transitory computer-readable medium described herein, correcting the defective pixel may be based on the multiple color gradients.

Some examples of the method, apparatuses, and non-transitory computer-readable medium described herein may further include operations, features, means, or instructions for determining a first interpolation direction based on determining a first color gradient along a first direction and a second color gradient along a second direction, determining a second interpolation direction based on determining a third color gradient along a third direction and a fourth color gradient along a fourth direction, and determining a direction weight based on the first color gradient, the second color gradient, the third color gradient, the fourth color gradient, or a combination thereof.

Some examples of the method, apparatuses, and non-transitory computer-readable medium described herein may further include operations, features, means, or instructions for determining a weighting pixel value of each pixel of the second set of neighboring pixels along the first interpolation direction, determining a weighting pixel value of each pixel of the second set of neighboring pixels along the second interpolation direction, and where correcting the defective pixel may be based on the weighting pixel value of each pixel of the second set of neighboring pixels along the first interpolation direction, or the weighting pixel value of each pixel of the second set of neighboring pixels along the second interpolation direction, or both.

In some examples of the method, apparatuses, and non-transitory computer-readable medium described herein, the weighting pixel value of each pixel of the second set of neighboring pixels along the first interpolation direction or the weighting pixel value of each pixel of the second set of neighboring pixels along the second interpolation direction, or both may be based on a preconfigured weighting pixel table.

Some examples of the method, apparatuses, and non-transitory computer-readable medium described herein may further include operations, features, means, or instructions for applying, to the defective pixel, a weighted sum of the weighting pixel value of each pixel of the second set of neighboring pixels along the first interpolation direction or a weighted sum of the weighting pixel value of each pixel of the second set of neighboring pixels along the second interpolation direction based on the direction weight.

In some examples of the method, apparatuses, and non-transitory computer-readable medium described herein, the weighting pixel value of a pixel of the second set of neighboring pixels along the first interpolation direction, or the second interpolation direction, or both may be zero based on the pixel being a phase detection pixel.

In some examples of the method, apparatuses, and non-transitory computer-readable medium described herein, the weighting pixel value of a pixel of the second set of neighboring pixels along the first interpolation direction or the second interpolation direction, or both may be non-zero based on the pixel being a non-phase detection pixel.

In some examples of the method, apparatuses, and non-transitory computer-readable medium described herein, the defective pixel includes a phase detection pixel.

In some examples of the method, apparatuses, and non-transitory computer-readable medium described herein, the configuration includes a second indication of a set of phase detection pixels in the CFA pattern.

### BRIEF DESCRIPTION OF THE DRAWINGS

FIG. 1 illustrates an example of a system for image processing that supports pattern configurable pixel correction in accordance with aspects of the present disclosure.

FIG. 2 illustrates an example of color filter array (CFA) patterns that support pattern configurable pixel correction in accordance with aspects of the present disclosure.

FIG. 3 illustrates an example of a process flow that supports pattern configurable pixel correction in accordance with aspects of the present disclosure.

FIG. 4 illustrates an example of a neighboring pixel configuration that supports pattern configurable pixel correction in accordance with aspects of the present disclosure.

FIG. 5 illustrates an example of a directional detection scheme that supports pattern configurable pixel correction in accordance with aspects of the present disclosure.

FIG. 6 illustrates an example of a directional interpolation scheme that supports pattern configurable pixel correction in accordance with aspects of the present disclosure.

FIGS. 7 and 8 show block diagrams of devices that support pattern configurable pixel correction in accordance with aspects of the present disclosure.

FIG. 9 shows a block diagram of a pattern configurable manager that supports pattern configurable pixel correction in accordance with aspects of the present disclosure.

FIG. 10 shows a diagram of a system including a device that supports pattern configurable pixel correction in accordance with aspects of the present disclosure.

FIGS. 11 through 13 show flowcharts illustrating methods that support pattern configurable pixel correction in accordance with aspects of the present disclosure.

### DETAILED DESCRIPTION

A device may have a component, such as a camera, configurable with one or more image sensors to capture image data (e.g., an image, a video, or the like). Image sensors may by default produce defect pixels that may degrade the quality of captured images. If defect pixels are not corrected before other image processing operations, image quality can be negatively impacted. In addition to defect pixels, other examples of pixels to correct may include phase detection (PD) pixels and PD autofocus (PDAF) pixels. An image sensor may be configurable with a color filter array (CFA) to determine color information for a captured image data.

Some techniques use a pixel correction scheme that is particularly designed for a defined CFA pattern, for example, such as a Bayer pattern. Support for other CFA patterns, such as a quad-color filter array (Q-CFA) pattern would necessitate the device to have added hardware and related resources to be capable of handling the additional CFA pattern, which has significant disadvantages. Being capable of handling multiple different CFA patterns may allow for greater flexibility in image processing operations, for example, based on lighting conditions (e.g., low light or bright light). In other examples of image processing operations, color interpolation operations implemented using a Q-CFA pattern may improve interpolation accuracy, gradient detection, color saturation, or the like. Challenges related to standing devices capable of supporting a single CFA pattern including reduced flexibility and efficiency when performing image processing operations.

The described techniques address the shortcoming of other devices and related techniques by supporting a pattern configurable pixel correction scheme. More specifically, the described techniques support image processing according to a pattern configurable pixel correction scheme for multiple different types of CFA patterns without added hardware cost to a device. The pattern configurable pixel correction scheme may use a set of configurable tables that may define one or more neighboring pixels relative to a target pixel location in a CFA pattern, as well PD pixels and PDAF pixels locations in the CFA pattern. The described techniques may therefore support image processing related operations that may include defect pixel detection and defect pixel correction according to various CFA patterns (e.g., Bayer, X-Trans, Q-CFA).

Defect pixel detection may include using a set of configurable tables in determining whether a current pixel is a defect pixel. The set of configuration tables may define locations of one or more neighboring pixels relative to a target pixel in a CFA pattern, as well as locations of PDAF pixels in the CFA pattern. The described techniques may determine whether the target pixel is defective based on, for example, a comparison between the pixel value of the target pixel and maximum and minimum pixel values of the neighboring pixels. In some examples, the pixel correction scheme may be applied to PDAF pixel correction. For example, the pixel correction scheme may treat PDAF pixels as pixel defects (e.g., treat defined PDAF pixel locations as locations of known pixel defects). By incorporating the known locations, the pixel correction scheme may omit the PDAF pixels from consideration when determining whether pixels included in a CFA are defect pixels. Configuration for different PDAF locations can be assigned to support any PDAF sensors.

Defect pixel correction may including using directional interpolation (e.g., horizontal, vertical, diagonal, non-diagonal directions) and blended weight calculations. In an example, the described techniques may use a gradient calculation, which may provide improvement in interpolation of pixels along edges. In some examples, the defect pixel correction may incorporate a weighted average of the pixels with respect to one or more directions. The weight may be based on, for example, a table having a set of weight entries corresponding to different distances to a center. Directional defect pixel correction may achieve higher quality pixel correction and can be directly used for high density PDAF pixel corrections.

Aspects of the disclosure are initially described in the context of a wireless communications system. Aspects of the disclosure are further illustrated by and described with reference to apparatus diagrams, system diagrams, and flowcharts that relate to pattern configurable pixel correction.

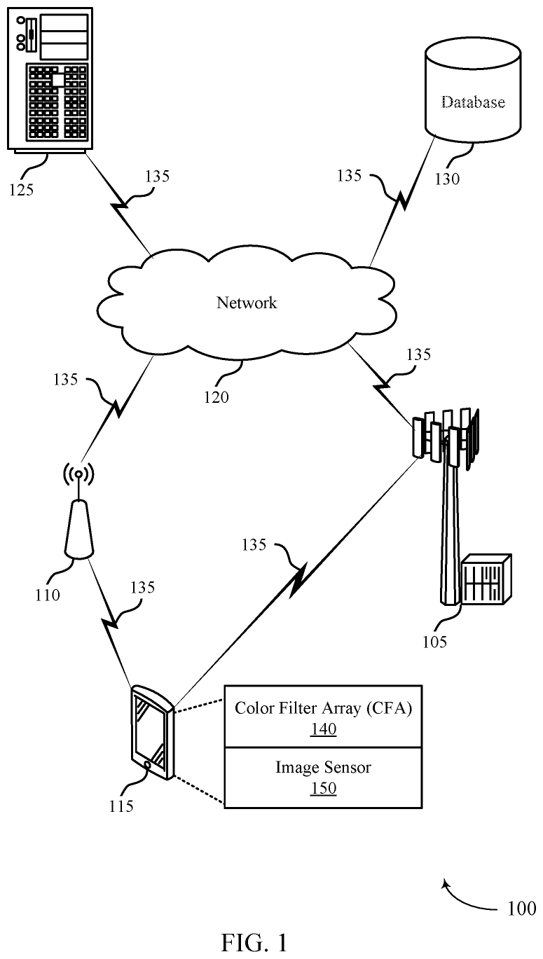

FIG. 1 illustrates an example of a system 100 for image processing that supports pattern configurable pixel correction in accordance with aspects of the present disclosure. The system 100 may include a base station 105, an access point 110, a device 115, a server 125, and a database 130. The base station 105, the access point 110, the device 115, the server 125, and the database 130 may communicate with each other via network 120 using communications links 135 to support image processing related operations.

The base station 105 may wirelessly communicate with the device 115 via one or more base station antennas. Base station 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The device 115 described herein may be able to communicate with various types of base stations and network equipment including macro eNBs, small cell eNBs, gNBs, relay base stations, and the like. The access point 110 may be configured to provide wireless communications for the device 115 over a relatively smaller area compared to the base station 105.

In some examples, the device 115 may be stationary and/or mobile. In further examples, the device 115 may include a cellular phone, a smartphone, a personal digital assistant (PDA), a wireless communication device, a handheld device, a tablet computer, a laptop computer, a cordless phone, a display device (e.g., monitors), and/or the like. The device 115 may, additionally or alternatively, include or be referred to by those skilled in the art as a UE, a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the device 115 may also be able to communicate directly with another device (e.g., using a peer-to-peer (P2P) or device-to-device (D2D) protocol).

In some examples, the device 115 may include a CFA 140 and an image sensor 150. The image sensor 150 may be a camera, for example, such as a standalone camera, a digital camera, a stereo camera, and/or the like that may be integrated with the device 115. For example, the image sensor 150 may capture a pixel array (e.g., an image) representing a scene. The image sensor 150 may generate a two-dimensional pixel array representing the scene. In some cases, the two-dimensional pixel array may be generated in the Bayer domain (e.g., based on a filter coupled with photodiodes including one or more sensors). The CFA 140 may obtain color information for an image. In some examples, the CFA 140 may include a pattern of color filters placed over the image sensor 150 to capture color information. In some examples, this may include a color filter being associated with each pixel sensor of an array. Accordingly, each pixel sensor may collect color data based on the color (e.g., RGB) of the filter that is associated with that pixel. Color images (e.g., RGB, YUV or the like) can be reconstructed using an interpolation method (e.g., demosaicing) to estimate or calculate the missing color values.

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3g), fourth generation (4G), long-term evolved (LTE), or new radio (NR) systems (e.g., fifth generation (5G) for example), etc. Network 120 may include the Internet.

The server 125 may include any combination of a data server, a cloud server, a server associated with an automation service provider, proxy server, mail server, web server, application server, database server, communications server, home server, mobile server, or any combination thereof. The server 125 may also transmit to the device 115 a variety of information, such as instructions or commands (e.g., configuration information) relevant to supporting image processing related operations for pattern configurable pixel correction. Server 125 may include an application distribution platform. For example, the device 115 may upload or download applications such as social network applications for uploading, posting multimedia (e.g., images, audio, video). In another example, the device 115 may download an image processing application from the server 125. The image processing application may provide image enhancements, image restoration, image analysis, image compression, and image synthesis. For example, the device 115 may provide image enhancements, image restoration, image analysis, image compression, and image synthesis to a scene captured in a pixel array.

The database 130 may store data that may include instructions or commands (e.g., configuration information) relevant to supporting image processing related operations for pattern configurable pixel correction. The device 115 may retrieve the stored data from the database 130 via the base station 105 and/or the access point 110. For example, upon receiving a request to provide a configuration file to device 115, server 125 may parse and retrieve the configuration file, from the database 130, based on the information provided in the request (e.g., configuration identifier, operating system type (e.g., Linux, Unix, Mac OS X, Windows, etc.) of device 115) and provide the configuration file to the device 115 via the communications links 135. The device 115 may receive the configuration file and apply it to an image processing operation. For example, device 115 apply the configuration file to an image signal processor (ISP) to use in pattern configurable pixel correction.

The communications links 135 shown in the system 100 may include uplink transmissions from the device 115 to the base station 105, the access point 110, or the server 125, and/or downlink transmissions, from the base station 105, the access point 110, the server 125, and/or the database 130 to the device 115. The downlink transmissions may also be called forward link transmissions while the uplink transmissions may also be called reverse link transmissions. The communications links 135 may transmit bidirectional communications and/or unidirectional communications. The communications links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

Accordingly, the techniques described herein may provide improvements in image processing related operations, and more specifically may provide a device 115 capability to perform defect pixel detection and pixel correction for multiple types of CFA patterns.

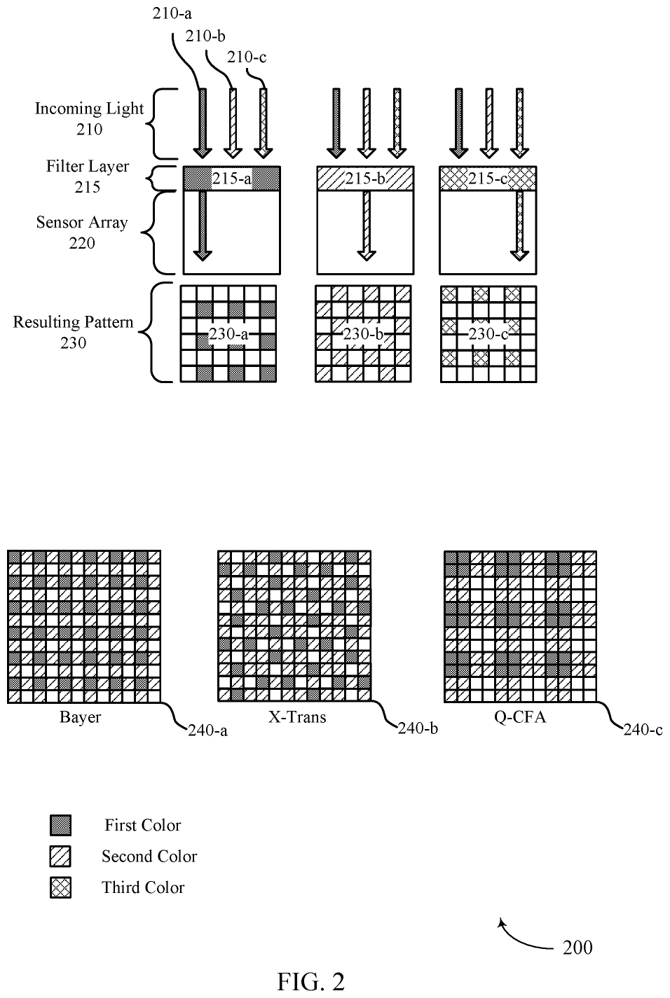

FIG. 2 illustrates an example of CFA patterns 200 that support pattern configurable pixel correction in accordance with aspects of the present disclosure. In some examples, CFA patterns 200 may implement aspects of system 100. For example, a filter layer 215 and a sensor array 220, may be respectively included in the CFA 140 and the image sensor 150 of FIG. 1. In the example of FIG. 2, incoming light 210 may be filtered at the filter layer 215 and output to the sensor array 220 according to a resulting pattern 230. The filter layer 215 may include color filters 215-a through 215-c, each filtering light according to a different wavelength range, and the color filters 215-a through 215c may be configured according to a CFA pattern. Light propagating out of the filter layer 215 (e.g., light 210-a through 210-c respectively leaving color filters 215-a through 215c) may reach pixel sensors (e.g., photosensors) included in the sensor array 220 as image data, in accordance with patterns 230-a through 230-c.

Examples of CFA patterns may include, but are not limited to, Bayer, X-Trans, and Q-CFA, which are respectively denoted by 240-a, 240-b, and 240-c. The Bayer CFA pattern 240-a may include a repeating pattern of red, green and blue (RGB) color filters. The Bayer CFA pattern 240-a may use at least two green color filters for each red and blue color filter (e.g., 50% green, 25% red and 25% blue), which may be based on the physiology of the human eye. The X-Trans CFA pattern 240-b may be capable of reducing moire effects and increase resolution, thereby eliminating requirement for a low-pass filter implementation. The Q-CFA pattern 240-c may have certain repetition of a color array, for example, every two-by-two pixel array may be of the same color (e.g., red, blue, green). The Q-CFA pattern 240-c may promote more flexible processing of the image sensor data, for example, based on the light conditions of captured image data. In some examples, utilizing different CFA patterns may provide different image outputs, decrease the image processing overhead or otherwise improve or increase the efficiency of image signal processing.

In some examples, shortcoming of other ISP configured devices include a need for multiple hardware modules and/or algorithms to accommodate multiple types of CFA patterns. In the example of FIG. 2, image data may be processed by a remosaicing system to produce a second set of image data, which may include interpolated values for each color included therein (e.g., a set of RGB image data). The second set of image data may be mapped or sampled to a CFA pattern (e.g., Bayer CFA pattern 240-a) different from the CFA pattern used to capture the initial image data, thus producing a third set of image data. The third set of data may be processed by an ISP to produce a final set of image data (e.g., an RGB image data set). The final set of image data may be further processed, encoded or displayed by an image input or output device such as an image encoder, a video encoder, or a display. Further, because defect pixels are inherent to image sensors, regardless of the CFA pattern, these defect pixels may need to be corrected before other image processing blocks to avoid reductions in image quality. PD pixels and PDAF pixels, which may be used in image sensors (e.g., CMOS sensors) to speed up auto focus operations may be examples of pixels which may be corrected to avoid such reductions in quality.

Techniques will be described herein which overcome the limitations of other ISP devices. The proposed techniques may include defect pixel detection and defect pixel correction, configurable according to CFA pattern (e.g., Bayer, X-Trans, and Q-CFA). Through different configurations, a single hardware module and/or set of algorithms applicable to existing and future CFA patterns may be achieved (e.g., universal defect pixel correction).

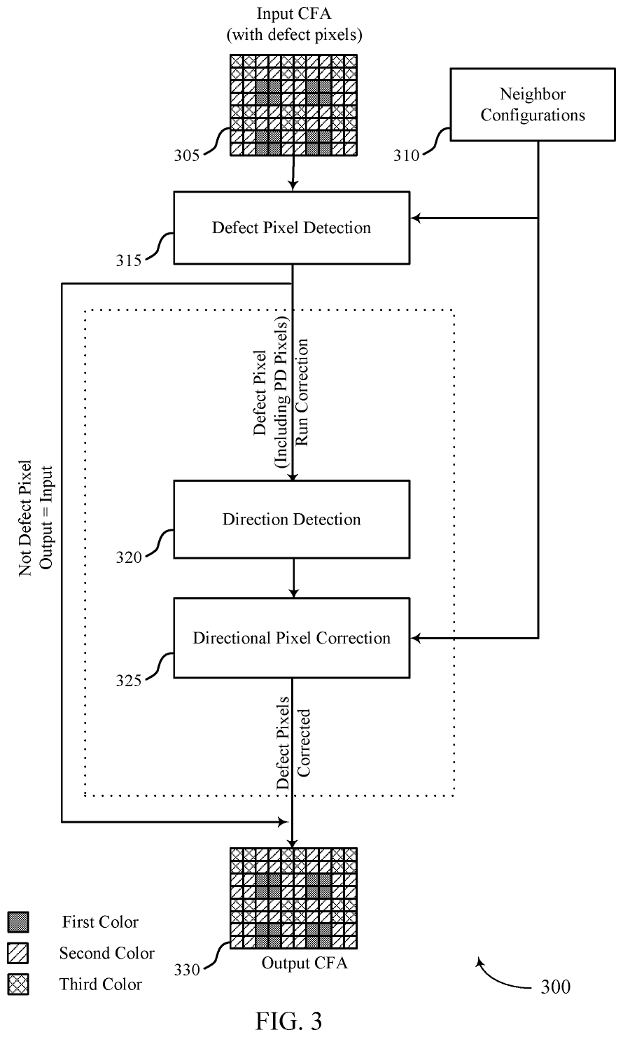

FIG. 3 illustrates an example of a process flow 300 that supports pattern configurable pixel correction in accordance with aspects of the present disclosure. The process flow 300 may implement aspects of the system 100, such as providing improvements in defect pixel detection and pixel correction. The process flow 300 may be performed by one or more devices as described with reference to FIG. 1, for examples, such as device 115. In the following description of the process flow 300, the operations may be performed in a different order than the exemplary order shown, or the operations may be performed in different orders or at different times. Certain operations may also be omitted from the process flow 300, and/or other operations may be added to the process flow 300.

At 305, device 115 may process an input CFA 305. The input CFA 305 may be, for example, a Bayer CFA, an X-Trans CFA, or a Q-CFA, and may include color filters arranged according to a corresponding CFA pattern. In an example, the color filters may include three colors (e.g., red, green, and blue). In some examples, device 115 may capture image data based on a CFA associated with an image sensor. The image data may include a set of pixels. In some other examples, device 115 may determine a CFA pattern of the CFA associated with the image sensor. For example, device 115 may determine that the CFA associated with the image sensor is at least one of a Bayer CFA, an X-Trans CFA, or a Q-CFA, or any combination thereof.

At 310, device 115 may determine one or more neighboring configurations. For example, device 115 may identify one or more configurable tables (also referred to herein as configuration) that may be used to define neighboring pixels with respect to pixels included in the input CFA 305. In some examples, device 115 may select a configuration based on the CFA pattern, for example, according to A CFA pattern type, such as a Bayer CFA pattern, X-Trans CFA pattern, or Q-CFA pattern. A configuration table may define pixel values of the set of pixels included in the input CFA 305, as well as pixel values of corresponding neighboring pixels.

For example, the configuration may include an indication of a first set of neighboring pixels for each pixel of the set of pixels to use to determine that a pixel is defective and a second set of neighboring pixels for each pixel of the set of pixels to use to correct the defective pixel. In some other examples, a configuration table may define one or more sets of neighboring pixels based on a number of pixels included in the input CFA 305. For example, where the input CFA 305 has a 4-by-4 CFA pattern, a configuration table may define 16 sets of neighbors (e.g., neighboring pixels). A configurable table may also include information indicating locations of PDAF pixels included in the input CFA 305, for example, according to CFA pattern type.

At 315, device 115 may perform defect pixel detection. For example, device 115 may analyze pixels included in the input CFA 305 to determine whether any of the pixels are defects (e.g., defect pixels). Device 115 may determine whether a current pixel (e.g., target pixel) included in the CFA 305 is a defect based on a pixel value of the current pixel and pixel values of neighboring pixels (e.g., pixels which neighbor the current pixel). For example, device 115 may determine a first pixel value of the pixel of the set of pixels, determine a second pixel value of each pixel of the first set of neighboring pixels, and compare the first pixel value to the second pixel value. Based on the comparison, device 115 may determine that the pixel of the set of pixels is defective. In some examples, the pixel of the set of pixels is a center pixel in the first set of neighboring pixels.

In some other examples, device 115 may identify and handle PDAF pixels as defect pixels. For example, device 115 may identify PDAF pixels included in the input CFA 305, and further, may refer to the corresponding locations of the PDAF pixels when identifying defect pixels in the input CFA 305. For example, device 115 may handle locations of PDAF pixels in the input CFA 305 as known locations of pixel defects, and further, skip over the known locations when identifying defect pixels. In some other examples, device 115 may obtain information identifying the PDAF pixels and corresponding locations from one or more configurable tables.

In some examples of the process flow 300, if device 115 determines that no defect pixels are present in the input CFA 305, device 115 may skip defect pixel correction and directly output the input CFA 305 as the output CFA 330. Otherwise, device 115 may determine that a defect pixel is present in the input CFA 305, and may proceed to perform pixel correction.

At 320, device 115 may perform a direction detection. For example, device 115 may determine one or more interpolation directions for pixel correction. At 325, device 115 may perform a direction pixel correction. Here, for example, device 115 may correct defect pixels by interpolating neighbors (e.g., interpolating pixel values of neighboring pixels) in the one or more interpolation directions. Following the directional pixel correction, at 330, device 115 may output the output CFA 330.

By way of example, device 115 may identify a first pixel value, which may be a maximum pixel value, of the first set of neighboring pixels based on the pixel value of each pixel of the first set of neighboring pixels, and determine that the pixel value of the pixel of the set of pixels is greater than the first pixel value (e.g., maximum pixel value) of the first set of neighboring pixels by a threshold pixel value. The threshold pixel value may be configurable based on a set of tuning parameters including a weighting factor, the first pixel value, or a pixel offset value, or a combination thereof. Device 115 may clamp the pixel value of the pixel of the set of pixels with the first pixel value to correct the defective pixel of the set of pixels. In some other examples, device 115 may identify a different pixel value, which may be a minimum pixel value, of the first set of neighboring pixels based at least in part on the pixel value of each pixel of the first set of neighboring pixels, determine that the pixel value of the pixel of the set of pixels is less than the minimum pixel value of the first set of neighboring pixels by a threshold pixel value, and clamp the pixel value of the pixel of the set of pixels with the minimum pixel value to correct the defective pixel.

In other examples, device 115 may determine multiple color gradients based on a kernel. The kernel may include the pixel and the second set of neighboring pixels. Each color gradient of the multiple color gradients characterizes a color variation along a different direction. By way of example, device 115 may determine a first interpolation direction based at least in part on determining a first color gradient along a first direction and a second color gradient along a second direction, and a second interpolation direction based at least in part on determining a third color gradient along a third direction and a fourth color gradient along a fourth direction.

Device 115 may then determine a direction weight based at least in part on the first color gradient, the second color gradient, the third color gradient, the fourth color gradient, or a combination thereof. In some examples, device 115 may determine a weighting pixel value of each pixel of the second set of neighboring pixels along the first interpolation direction, and determine a weighting pixel value of each pixel of the second set of neighboring pixels along the second interpolation direction. Here, device 115 may correct the defective pixel based on the weighting pixel value of each pixel of the second set of neighboring pixels along the first interpolation direction, or the weighting pixel value of each pixel of the second set of neighboring pixels along the second interpolation direction, or both.

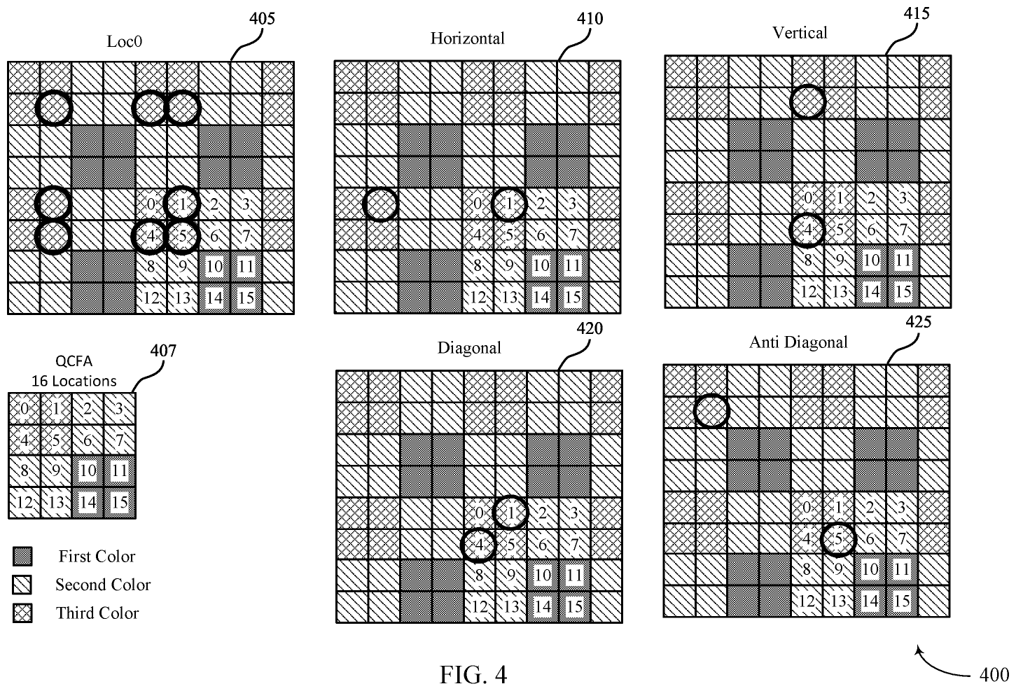

FIG. 4 illustrates an example of a neighboring pixel configuration 400 that supports pattern configurable pixel correction in accordance with aspects of the present disclosure. In some examples, the neighboring pixel configuration 400 may implement aspects of system 100. The neighboring pixel configuration 400 may be implemented by one or more devices as described with reference to FIG. 1, for examples, such as device 115.

The neighboring pixel configuration 400 may include device 115 selecting a configuration, for example, selecting a set of neighbors (e.g., neighboring pixels) for each pixel location based on a CFA pattern (e.g., a Q-CFA pattern having a first color, a second color, and a third color). In the example of FIG. 4, the CFA pattern may be an example 4-by-4 Q-CFA pattern 407, in which a set of neighboring pixels are configured for each of the 16 locations (locations 0 through 15) of the Q-CFA pattern 407. For example, each set includes M neighboring pixels for defect pixel detection and N neighboring pixels for direction detection. In the example of FIG. 4, M may be 8 and N may be 8 (e.g., four directions, with two neighboring pixels for each direction).

Neighboring pixel configuration 405 shows an example neighboring pixel configuration in which eight neighboring pixels (each denoted by a solid circle) are configured for an initial location (location 0 (Loc0)) for the Q-CFA pattern 407 (e.g., eight pixels which neighbor a pixel located at Loc0 (denoted by ‘0’) are defined or identified, in addition to corresponding locations of the eight pixels). By way of example, neighboring pixel configuration 415 shows an example of neighboring pixels defined in a horizontal direction for Loc0 for the Q-CFA pattern 407, neighboring pixel configuration 415 an example of neighboring pixels defined in the vertical direction for Loc0 for the Q-CFA pattern 407, neighboring pixel configuration 420 shows an example of neighboring pixels defined in the diagonal direction for Loc0 for the Q-CFA pattern 407, and neighboring pixel configuration 425 shows an example of neighboring pixels defined in the cross-diagonal direction for Loc0 for the Q-CFA pattern 407.

As illustrated in neighboring pixel configuration 405 through 425, each of the neighboring pixels defined in relation to the pixel located at Loc0 is at a pixel location which is the same color as that of the pixel located at Loc0. For example, in accordance with aspects of neighbor configurations as described herein, the pixel located at Loc0 and all of the defined neighboring pixels defined in relation to the pixel located at Loc0 are located at pixel locations corresponding to the third color. Aspects of neighbor configurations are not limited thereto, and although not illustrated, neighboring pixels may be defined for any or all of the 16 locations (locations 0 through 15) for the Q-CFA pattern 407. According to the configurations, a target pixel (e.g., a pixel located at any of Loc0 through Loc16) and neighboring pixels defined in relation to the target pixel may be located at pixel locations corresponding to the same color (e.g., the first color, the second color, or the third color).

With reference to FIG. 3, device 115 may detect defect pixels in the input CFA 305 based on neighbor configurations. For example, based on neighbor configurations, device 115 may obtain (e.g., identify or calculate) maximum (e.g., highest) and minimum (e.g., lowest) pixel values of neighboring pixels in relation to target pixels included in the input CFA 305. Further, device 115 may compare the pixel values of target pixels included in the input CFA 305 to max and min pixel values of corresponding neighboring pixels. If the value of a target pixel (e.g., center pixel) is significantly larger than the max pixel value of the corresponding neighboring pixels, device 115 may identify or classify the target pixel as a hot pixel. If the value of a target pixel (e.g., center pixel value) is significantly smaller than the min pixel value of the corresponding neighboring pixels, device 115 may identify the target pixel as a cold pixel. The pixel value of each pixel may be a color value. The example detection criteria outlined below, as merely some examples, may be incorporated during the comparison of max and min pixel values of neighboring pixels in relation to the pixel value of a target pixel:

Hot pixel: center>Fmax*max+offset (1)

Cold pixel: center<Fmin*min-offset (2)

Fmax, Fmin and offset are tuning parameters (3)

In terms of tuning and calibration in relation to Fmax, Fmin, and offset, device 115 may tune the ratio and the offset for the defect pixel correction.

In some examples, device 115 may correct a defect pixel by replacing the pixel value of the defect pixel with the max pixel value ‘max’ among neighboring pixels (in the case of a hot pixel) or the min pixel value ‘min’ among neighboring pixels (in the case of a cold pixel) value via, for example, a technique referred to as clamping. However, aspects of the present disclosure also describe defect pixel correction through directional interpolation, which can further improve pixel correction results. Defect pixel correction through directional interpolation will be described in detail further below.

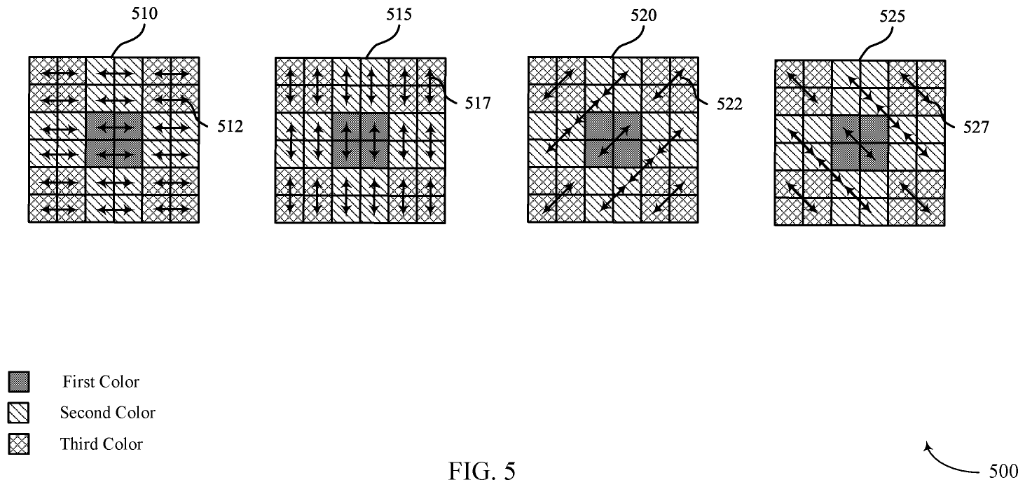

FIG. 5 illustrates an example of a directional detection scheme 500 that supports pattern configurable pixel correction in accordance with aspects of the present disclosure. In some examples, directional detection scheme 500 may implement aspects of system 100. For example, directional detection scheme 500 may be implemented by one or more devices as described with reference to FIG. 1, for examples, such as device 115. Directional detection scheme 500 may include a gradient calculation, a gradient accumulation, a direction determination, a weight calculation, or a combination thereof.

The directional detection scheme 500 may include calculating same-channel color gradients (e.g., color gradients across regions/pixels of the same color), cross-channel color gradients (e.g., color gradients across regions/pixels of different colors), or a combination thereof. In some cases, the directional detection scheme 500 may also include calculating one or more horizontal color gradients 510, vertical color gradients 515, diagonal color gradients 520, cross-diagonal (e.g., anti-diagonal) color gradients 525, or a combination thereof.

In some cases, a gradient calculation may include calculating a color gradient for each of a horizontal color gradient 510 (inclusive of horizontal gradient components 512), a vertical color gradient 515 (inclusive of vertical gradient components 517), a diagonal color gradient 520 (inclusive of diagonal gradient components 522), and an cross-diagonal (e.g., anti-diagonal) color gradient 525 (inclusive of cross-diagonal gradient components 527). For example, a vertical color gradient may be calculated using both same-channel color gradients and cross-channel color gradients. The same-channel color gradient may include calculating one or more vertical gradient components across neighboring regions or pixels of the same color. The cross-channel color gradient may include calculating one of more vertical gradient components across neighboring regions or pixels of different colors.

According to aspects of the present disclosure, based on gradients calculated in the horizontal (H), vertical (V), diagonal (N), and cross-diagonal (Z) directions, the directional detection scheme 500 may output, for example, the following information: vh_idx, nz_idx, vh_weight, and blended weight with respect to V, H, N, and Z directions. Accordingly, device 115 may support a three-color (e.g., RGB) interpolation for defect pixel correction by using the directions and blended weight to interpolate defect pixels (e.g., identify defect pixels through directional interpolation).

In some examples, device 115 may using directional detection scheme 500 calculate the gradients in the H, V, N, and Z directions according to the following equations. The horizontal color gradient 510 may be calculated by the following equation, as one example.

$${h}_{diff} = \sum \vert ∇ {hs}_{i} \vert \times \frac{h {c}_{c n t}}{h {s}_{c n t}} \qquad ( 4 )$$

In Equation 4, |∇hsᵢ| may define an absolute value of a same-channel horizontal gradient component, i (e.g., where i is a number representing each of the different horizontal gradient components 512), which may be calculated based on the difference in color values between a first region/pixel and an adjacent second region/pixel of the same color; hc_{cnt} may define a number of cross-channel horizontal gradient components, hs_{cnt} may define a number of same-channel horizontal gradient components, and hc_{cnt}/hs_{cnt} may be a ratio of a number of cross-channel horizontal gradient components to same-channel horizontal gradient components.

In some examples, device 115 may calculate the vertical color gradient 515 similar to the horizontal color gradient 510. For example, the vertical color gradient 515 may be calculated by the following equation, as one example.

$${v}_{diff} = \sum \vert ∇ v {s}_{i} \vert \times \frac{v {c}_{c n t}}{v {s}_{c n t}} \qquad ( 5 )$$

In Equation 5, |∇vsᵢ | may define an absolute value of a same-channel vertical gradient component, i (e.g., where i is a number representing each of the different vertical gradient components 517), which may be calculated based on a difference in color values between a first region/pixel and an adjacent second region/pixel of the same color; vc_{cnt} may a number of cross-channel vertical gradient components, vs_{cnt} may be a number of same-channel vertical gradient components, and vc_{cnt}/vs_{cnt} may be a ratio of a number of cross-channel vertical gradient components to same-channel vertical gradient components. In some example, device 115 may calculate the diagonal color gradient 520 similar to the horizontal or vertical color gradients. For example, the diagonal color gradient 520 may be calculated according to Equation 6 shown below, as one example.

$${n}_{diff} = \sum \vert ∇ n {s}_{i} \vert \times \frac{n {c}_{c n t}}{n {s}_{c n t}} \qquad ( 6 )$$

In Equation 6, |∇zsᵢ| may define an absolute value of a same-channel diagonal gradient component, i (e.g., where i is a number representing each of the different diagonal gradient components 522), which may be calculated based on a difference in color values between a first region/pixel and an adjacent second region/pixel of a same color; nc_{cnt} may be a number of cross-channel diagonal gradient components, ns_{cnt} may be a number of same-channel diagonal gradient components, and nc_{cnt}/ns_{cnt} may be a ratio of a number of cross-channel diagonal gradient components to a same-channel diagonal gradient components.

In some example, device 115 may calculate the cross-diagonal color gradient 525 similar to the vertical, horizontal, or diagonal color gradients. For example, the cross-diagonal color gradient 525 may be calculated according to Equation 7 shown below, as one example.

$${Z}_{diff} = \sum \vert ∇ z {s}_{i} \vert \times \frac{z {c}_{c n t}}{z {s}_{c n t}} \qquad ( 7 )$$

In Equation 7, |∇zsᵢ| may be define an absolute value of a same-channel cross-diagonal gradient component, i (e.g., where i is a number representing each of the different cross-diagonal gradient components 527), which may be calculated based on a difference in color values between a first region/pixel and an adjacent second region/pixel of a same color; zc_{cnt} may be a number of cross-channel cross-diagonal gradient components, zs_{cnt} may be a number of same-channel cross-diagonal gradient components, and zc_{cnt}/zs_{cnt} may be a ratio of a number of cross-channel cross-diagonal gradient components to same-channel cross-diagonal gradient components.

Further aspects of the present disclosure may include directional detection according to V/H/N/Z direction index and V/H/N/Z weight calculation (e.g., four direction detection and blending weight calculation).

For example, in some cases, the directional determination (e.g., directional detection) and weight calculation may be based on the gradient calculations. For example, an interpolation may be performed for a first color of a CFA according to one or more directions. In this regard, for the first color (e.g., red) a first interpolation direction may be selected from either a vertical direction (Gᵥ) or a horizontal direction (Gₕ). The first interpolation direction may be selected based on the vertical/horizontal direction index (e.g., vh_{idx}). In some cases, first interpolation direction may be selected based on the more dominant color gradient direction over the kernel window. For example, the first interpolation direction may be selected according to Equation 8 shown below, as one example.

If: v_{diff}<h_{diff}

then vh_{idx}=Gₕ

Else: vh_{idx}=Gᵥ (8)

In Equation 8, v_{diff} may represent the vertical color gradient 515 over the kernel window, h_{diff} may represent the horizontal color gradient 510 over the kernel window, and vh_{idx} may be the vertical horizontal direction index. If h_{idx}=Gₕ then the first interpolation direction may be based on a horizontal direction. If vh_{idx}=Gᵥ then then first interpolation direction may be based on a vertical direction.

Additionally, or alternatively, an interpolation for the first color (e.g., red) may also be based on a second interpolation direction. In some cases, the second interpolation direction may be selected from either a diagonal direction (Gₙ) or a cross-diagonal direction (G_{z}). The second interpolation direction may be selected based on the diagonal/cross-diagonal direction index (e.g., nz_{idx}). In some cases, the second interpolation direction may be selected based on the more dominant color gradient direction over the kernel window. For example, the second interpolation direction may be selected according to Equation 9 shown below, as one example.

If: n_{diff}<z_{diff} then nz_{idx}=_{z}

Else: nz_{idx}=Gₙ (9)

In Equation 9, n_{diff} may represent the diagonal color gradient 520 over the kernel window, Z_{diff} may represent the cross-diagonal color gradient 525 over the kernel window, and nz_{idx} may be the vertical horizontal direction index. If nz_{idx}=G_{z} then the second interpolation direction may be based on a cross diagonal direction. If nz_{idx}=Gₙ then the second interpolation direction may be based on a diagonal direction.

In some cases, the interpolation procedure may also include a weight parameter (e.g., vh_{weight}). The weight parameter may be determined based on a comparison of the first interpolation direction to the second interpolation direction. For example, if the first interpolation direction color gradient is determined to be more dominant than the second interpolation direction color gradient and a threshold is met, then the weight parameter may be set to a first value to increase the effect of the first interpolation direction on the outputted interpolation value for the first color (e.g., red). Similarly, if the second interpolation direction color gradient is determined to be more dominant than the first interpolation direction color gradient and a threshold is met, then the weight parameter may be set to a second value to increase the effect of the second interpolation direction on the outputted interpolation value for the first color. For example, the weight parameter may be determined according to (10) shown below, as one example.

$$If \text{:} {vh}_{str} > 2 \times n {z}_{str} \& v {h}_{diff \text{-} m i n} < n {z}_{diff \text{-} m i n} \\ then {vh}_{w e i g h t} = 1 \\ Else if \text{:} {nz}_{str} > 2 \times v {h}_{str} \& v {h}_{diff \text{-} m i n} > n {z}_{diff \text{-} m i n} \\ then {vh}_{w e i g h t} = 0 \\ Else \text{:} {vh}_{w e i g h t} = \frac{n {z}_{diff \text{-} m i n}}{( n {z}_{diff \text{-} m i n} + v {h}_{diff \text{-} m i n} )} \qquad ( 10 )$$

The variables in (10) may be determined according to Equations 11-14 shown below, as one example.

$$\begin{matrix}v {h}_{str} = \frac{max ( {v}_{d iff} , {h}_{diff} )}{min ( {v}_{diff} , {h}_{diff} )} & ( 11 ) \\ {nz}_{str} = \frac{max ( {n}_{diff} , {z}_{diff} )}{min ( {n}_{diff} , {z}_{diff} )} & ( 12 ) \\ v {h}_{diffmin} = min ( {v}_{diff} , {h}_{diff} ) & ( 13 ) \\ n {z}_{diff \text{-} m i n} = min ( {n}_{diff} , {z}_{diff} ) & ( 14 )\end{matrix}$$

In Equations 11-14, max(v_{diff}, h_{diff}) may be the larger of the calculated values between the v_{diff} and h_{diff} for the kernel and min(v_{diff}, h_{diff}) may the smaller of the calculated values v_{diff} and h_{diff} for the kernel. Similarly, max(n_{diff}, z_{diff}) may be the larger of the calculated values between the n_{diff} and z_{diff} for the kernel and min(n_{diff}, z_{diff}) may the smaller of the calculated values n_{diff} and z_{diff} for the kernel

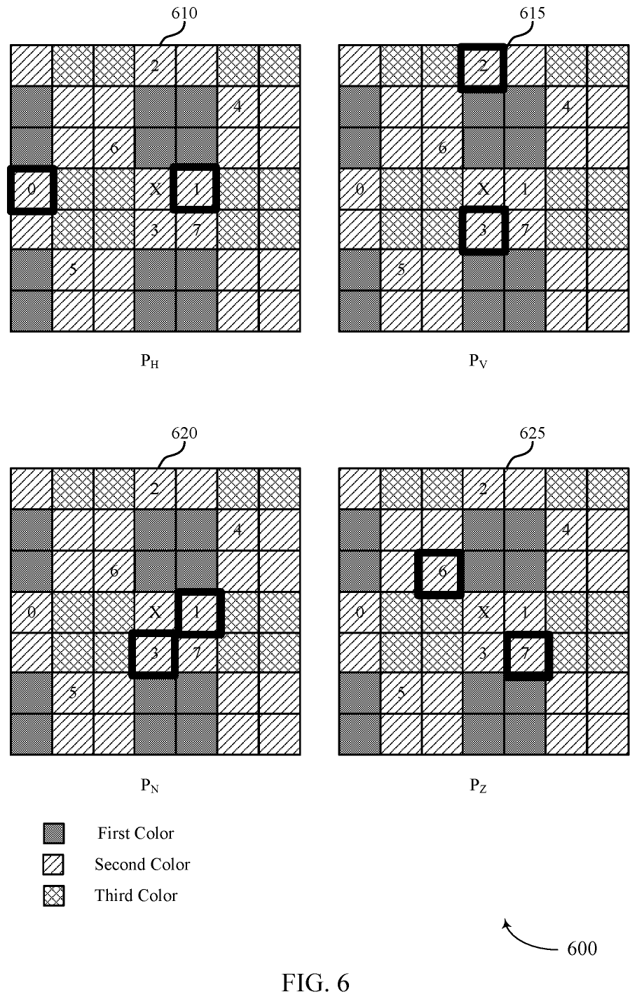

FIG. 6 illustrates an example of a directional interpolation scheme 600 that supports pattern configurable pixel correction in accordance with aspects of the present disclosure. In some examples, the directional interpolation scheme 600 may implement aspects of system 100. For example, directional interpolation scheme 600 may be implemented by one or more devices as described with reference to FIG. 1, for examples, such as device 115.

The directional interpolation scheme 600 may be performed on a subset of pixels of a CFA pattern with respect to a common color. That is, in some cases the directional interpolation scheme 600 may be performed on pixels of a first color (e.g., red) of a CFA array, for neighboring pixels defined in a horizontal direction, a vertical direction, a diagonal direction, and a cross-diagonal direction in relation to a target pixel (denoted by ‘X’ in FIG. 6). The directional interpolation scheme 600 may be performed to determine or estimate pixel values (e.g., color values) of the neighboring pixels included in the CFA pattern, and may be performed in combination with a weight table.

For example, a Q-CFA array may have a pattern including a first color (e.g., red), a second color (e.g., green), and a third color (e.g., blue). In some examples, to determine pixel values of a pixel having an unknown value (e.g., pixel denoted by ‘X’ in FIG. 6, where the pixel location is hereinafter referred to as ‘LocX’), the directional interpolation scheme 600 may use pixel values and corresponding weighting factors for neighboring pixels located in the horizontal direction, vertical direction, diagonal direction, and cross-diagonal direction with respect to the target pixel.

In an example aspect, the pixel value (e.g., color value) for the second color may be estimated for the pixel located at LocX, based on directional interpolation methods and interpolation direction gradients (e.g., interpolation direction color gradients) described herein. For example, the directional interpolation scheme 600 may compare interpolation direction color gradients with respect to different directions (e.g., horizontal direction, vertical direction, diagonal direction, and cross-diagonal direction) and apply weight parameters to directional interpolation calculations based on the comparisons.

In one example, the directional interpolation scheme 600 may compare the vertical interpolation direction color gradient to the horizontal interpolation direction color gradient and apply weight parameters to directional interpolation calculations based on the comparison. If the vertical interpolation direction color gradient is determined to be more dominant, then the directional interpolation scheme 600 may estimate the pixel value (e.g., second color value) at LocX using horizontal interpolation (e.g., If V gradient>H gradient, P_{VH} is P_{H}). In an example, the directional interpolation scheme 600 may use the pixel values (e.g., second color values) of neighboring pixels located at the pixel locations 0 and 1 shown in 610 of FIG. 6.

If the horizontal interpolation direction color gradient is determined to be more dominant, then the directional interpolation scheme 600 may estimate the pixel value (e.g., second color value) at LocX using vertical interpolation (e.g., If V gradient<H gradient, P_{VH} is P_{V}). In an example, the directional interpolation scheme 600 may use the pixel values (e.g., second color values) of neighboring pixels located at the pixel locations 2 and 3 as shown in 615 of FIG. 6.

In another example, the directional interpolation scheme 600 may compare the diagonal interpolation direction color gradient to the cross-diagonal interpolation direction color gradient and apply weight parameters to directional interpolation calculations based on the comparison. If the diagonal interpolation direction color gradient is determined to be more dominant, then the directional interpolation scheme 600 may estimate the pixel value (e.g., second color value) at LocX using cross-diagonal interpolation (e.g., If N gradient>Z gradient, P_{NZ} is P_{Z}). In an example, the directional interpolation scheme 600 may use the pixel values (e.g., second color values) of neighboring pixels located at the pixel locations 6 and 7 shown in 625 of FIG. 6.

If the cross-diagonal interpolation direction color gradient is determined to be more dominant, then the directional interpolation scheme 600 may estimate the pixel value (e.g., second color value) at LocX using diagonal interpolation (e.g., If N gradient<Z gradient, P_{NZ} is P_{N}). In an example, the directional interpolation scheme 600 may use the pixel values (e.g., second color values) of neighboring pixels located at the pixel locations 1 and 3 as shown in 620 of FIG. 6. In some cases, estimating or calculating the pixel value of a target pixel may include calculating a weighted average of the pixel values of neighboring pixels. In other cases, the color value may be calculated using the techniques and algorithms discussed herein, for example, as discussed in relation to FIG. 5.

The directional interpolation scheme 600 may use the following equation (15) in combination with pixel values (e.g., color values) of and pixel weights of neighboring pixels in correcting defect pixels through directional interpolation as described herein.

Pout=Pvh×vhweight+Pnz×(1−vhweight) (15)

where Pᵥₕ defines directional interpolation for vhidx and Pnz defines directional interpolation for nzidx. In some examples, device 115 may use the following constraints when correcting defect pixels through directional interpolation, as one example.

```
Directional_interpolation (dir)
{
if (dir== DIR_H)
return weighted_average(P0, P1, P0_weight,P1_weight)
if (dir== DIR_V)
return weighted_average(P2, P3, P2_weight,P3_weight)
if (dir== DIR_N)
return weighted_average(P1, P3, P1_weight,P3_weight)
if (dir== DIR_Z)
return weighted_average(P6,P7, P6_weight,P7_weight)
}
  weighted_average(X1, X2, X1_weight,X2_weight)
  {
  output = (P1 x P1_weight + P2 x P2_weight) /
  (P1_weight+P2_weight)
}
```

According to the above example constraints, if the directional interpolation scheme 600 estimates the pixel value (e.g., a second color value) at LocX using horizontal interpolation (e.g., dir==DIR_H), the directional interpolation scheme 600 may return a weighted average of respective pixel values (e.g., a second color values) and pixel weights of neighboring pixels located at the pixel locations 0 and 1 shown in 610 of FIG. 6. In some examples, if the directional interpolation scheme 600 estimates the pixel value (e.g., a second color value) at LocX using vertical interpolation (e.g., dir==DIR_V), the directional interpolation scheme 600 may return a weighted average of respective pixel values (e.g., a second color values) and pixel weights of neighboring pixels located at the pixel locations 2 and 3 shown in 615 of FIG. 6. In some examples, if the directional interpolation scheme 600 estimates the pixel value (e.g., a second color value) at LocX using cross-diagonal interpolation (e.g., dir==DIR_Z), the directional interpolation scheme 600 may return a weighted average of respective pixel values (e.g., second color values) and pixel weights of neighboring pixels located at the pixel locations 6 and 7 shown in 625 of FIG. 6. In some examples, if the directional interpolation scheme 600 estimates the pixel value (e.g., a second color value) at LocX using diagonal interpolation (e.g., dir==DIR N), the directional interpolation scheme 600 may return a weighted average of respective pixel values (e.g., a second color values) and pixel weights of neighboring pixels located at the pixel locations 1 and 3 shown in 620 of FIG. 6.

According to aspects of the example constraints, the directional interpolation scheme 600 may calculate a weighted average (expressed as weighted_average(X1, X2, X1_weight,X2_weight) in the algorithm) of two (2) neighboring pixels (e.g., a first pixel P1, a second pixel P2) based on respective pixel values (e.g., P1, P2) and respective pixel weights (P1_weight, P2_weight). Following the constraints above, and applying the same to the example shown in 610 of FIG. 6 regarding neighboring pixels located at the pixel locations 0 and 1, the directional interpolation scheme 600 may calculate a weighted average of respective pixel values (e.g., P0, P1) and pixel weights (e.g., P0_weight, P1_weight) of the neighboring pixels as being equal to (P0×P0_weight+P1×P1_weight)/(P0_weight+P1_weight). The exemplary constraints may similarly be applied to the examples shown in 615, 620, and 625 of FIG. 6 regarding neighboring pixels located at pixel locations 2 and 3, neighboring pixels located at pixel locations 1 and 3, and neighboring pixels located at pixel locations 6 and 7.

Further, in applying pixel weights for neighboring pixels in the above described directional interpolation calculations, the directional interpolation scheme 600 may use pixel weights based on proximity (e.g., number of pixel locations or pixel distance) and direction (e.g., in horizontal, vertical, diagonal, and cross-diagonal) with respect to the target pixel. For example, the directional interpolation scheme 600 may include the weight of eight direction pixels (e.g., the weights of 8 neighboring pixels located in horizontal, vertical, diagonal, and cross-diagonal directions with respect to the target pixel).

If the neighboring pixel is a PD pixel, the weight may be null. Further, if the neighboring pixel is not a PD pixel, the weight may be pre-calculated based on a distance to the target pixel (e.g., distance to the center), according to the example equation (16), as one example.

w=256/max(\sqrt{bx²+by²}, 1) (16)

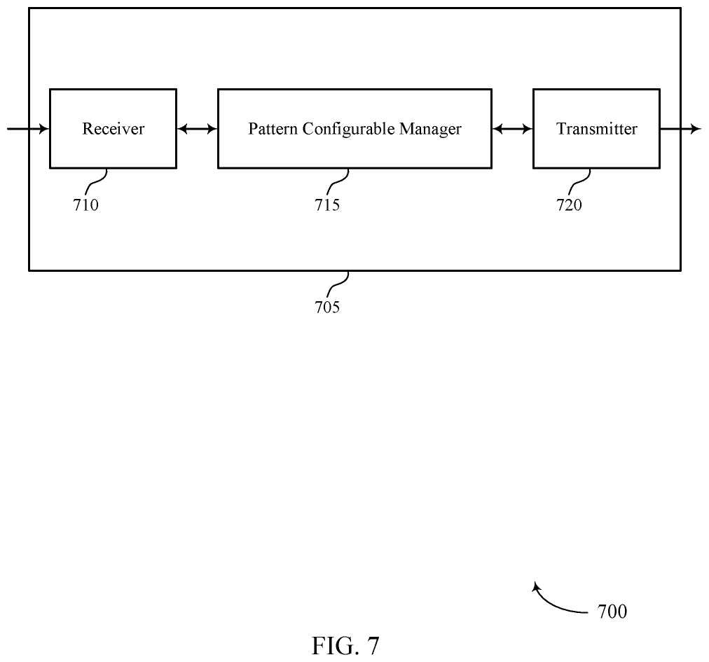

FIG. 7 shows a block diagram 700 of a device 705 that supports pattern configurable pixel correction in accordance with aspects of the present disclosure. The device 705 may be an example of aspects of a device as described herein. The device 705 may include a receiver 710, a pattern configurable manager 715, and a transmitter 720. The device 705 may also include a processor. Each of these components may be in communication with one another (e.g., via one or more buses).

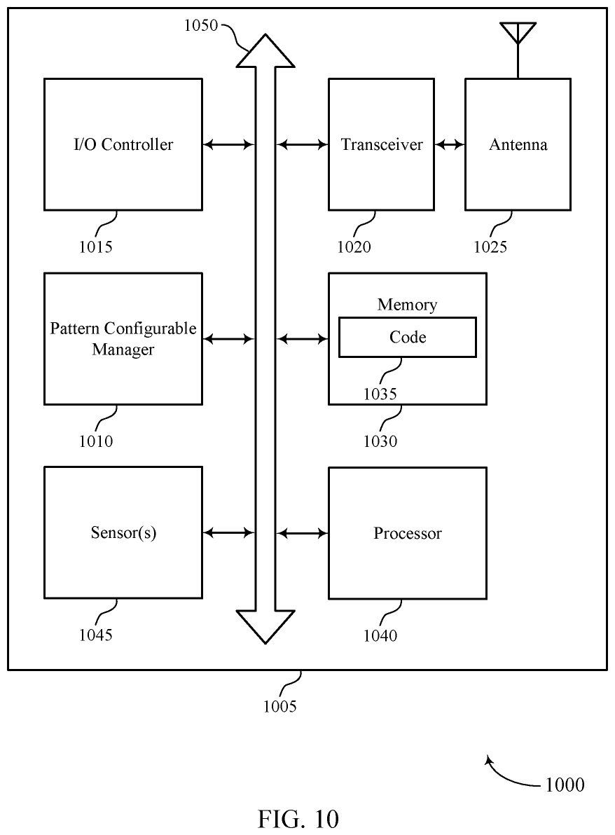

The receiver 710 may receive information such as packets, user data, or control information associated with various information channels (e.g., control channels, data channels, and information related to pattern configurable pixel correction, etc.). Information may be passed on to other components of the device 705. The receiver 710 may be an example of aspects of the transceiver 1020 described with reference to FIG. 10. The receiver 710 may utilize a single antenna or a set of antennas.

The pattern configurable manager 715 may capture image data based on a CFA associated with an image sensor, the image data including a set of pixels, determine a CFA pattern of the CFA associated with the image sensor, select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determine that the pixel of the set of pixels is defective using the configuration, and correct the defective pixel using pixel values of the first set of neighboring pixels, or pixel values of the second set of neighboring pixels, or both. The pattern configurable manager 715 may be an example of aspects of the pattern configurable manager 1010 described herein.

The pattern configurable manager 715, or its sub-components, may be implemented in hardware, code (e.g., software or firmware) executed by a processor, or any combination thereof. If implemented in code executed by a processor, the functions of the pattern configurable manager 715, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The pattern configurable manager 715, or its sub-components, may be physically located at various positions, including being distributed such that portions of functions are implemented at different physical locations by one or more physical components. In some examples, the pattern configurable manager 715, or its sub-components, may be a separate and distinct component in accordance with various aspects of the present disclosure. In some examples, the pattern configurable manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

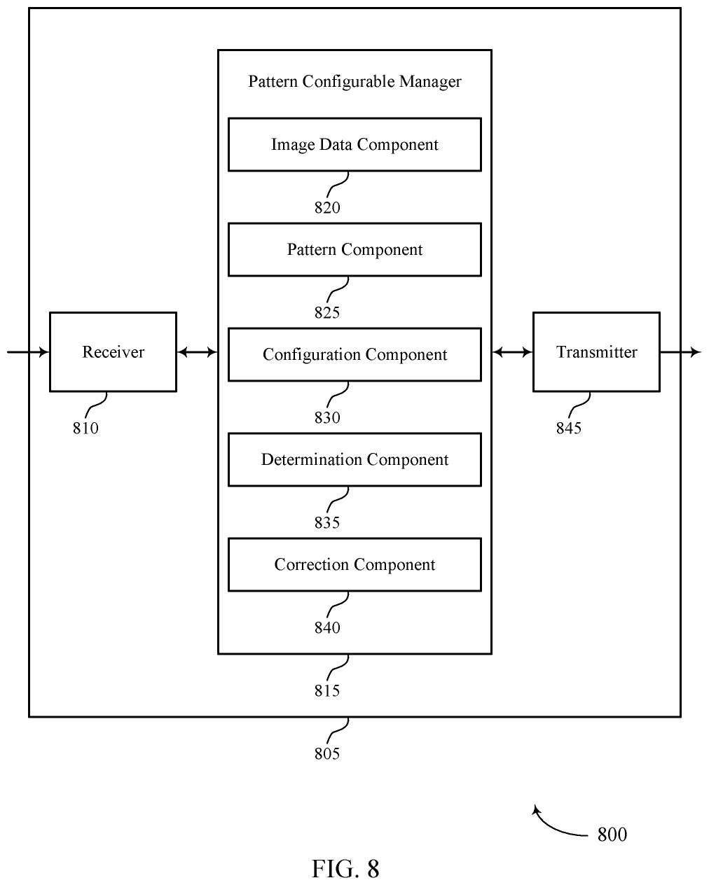

FIG. 8 shows a block diagram 800 of a device 805 that supports pattern configurable pixel correction in accordance with aspects of the present disclosure. The device 805 may be an example of aspects of a device 705 or a device 115 as described herein. The device 805 may include a receiver 810, a pattern configurable manager 815, and a transmitter 845. The device 805 may also include a processor. Each of these components may be in communication with one another (e.g., via one or more buses).

The receiver 810 may receive information such as packets, user data, or control information associated with various information channels (e.g., control channels, data channels, and information related to pattern configurable pixel correction, etc.). Information may be passed on to other components of the device 805. The receiver 810 may be an example of aspects of the transceiver 1020 described with reference to FIG. 10. The receiver 810 may utilize a single antenna or a set of antennas.

The pattern configurable manager 815 may be an example of aspects of the pattern configurable manager 715 as described herein. The pattern configurable manager 815 may include an image data component 820, a pattern component 825, a configuration component 830, a determination component 835, and a correction component 840. The pattern configurable manager 815 may be an example of aspects of the pattern configurable manager 1010 described herein.

The image data component 820 may capture image data based on a CFA associated with an image sensor, the image data including a set of pixels. The pattern component 825 may determine a CFA pattern of the CFA associated with the image sensor. The configuration component 830 may select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel. The determination component 835 may determine that the pixel of the set of pixels is defective using the configuration. The correction component 840 may correct the defective pixel using pixel values of the first set of neighboring pixels, or pixel values of the second set of neighboring pixels, or both.

The transmitter 845 may transmit signals generated by other components of the device 805. In some examples, the transmitter 845 may be collocated with a receiver 810 in a transceiver module. For example, the transmitter 845 may be an example of aspects of the transceiver 1020 described with reference to FIG. 10. The transmitter 845 may utilize a single antenna or a set of antennas.

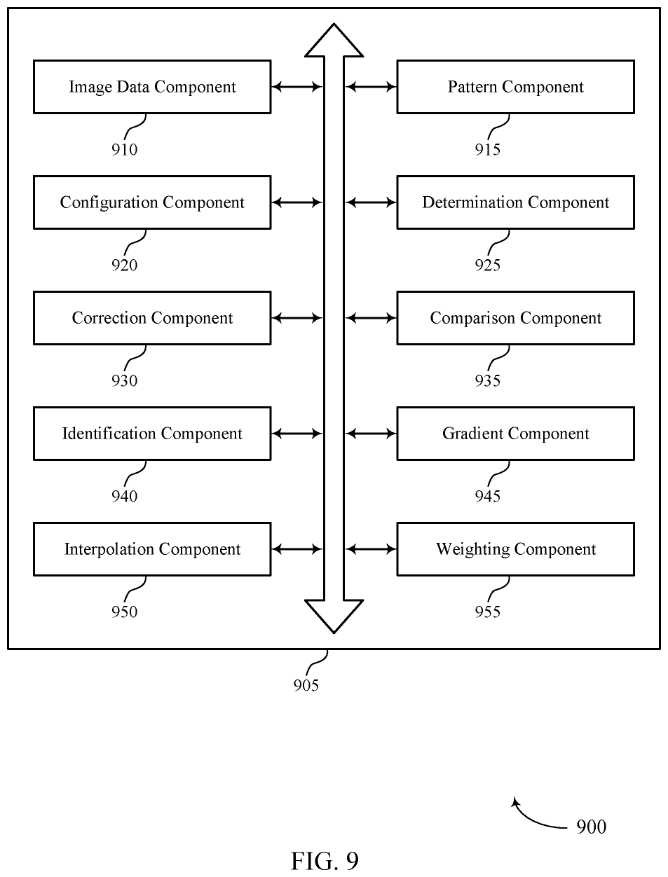

FIG. 9 shows a block diagram 900 of a pattern configurable manager 905 that supports pattern configurable pixel correction in accordance with aspects of the present disclosure. The pattern configurable manager 905 may be an example of aspects of a pattern configurable manager 715, a pattern configurable manager 815, or a pattern configurable manager 1010 described herein. The pattern configurable manager 905 may include an image data component 910, a pattern component 915, a configuration component 920, a determination component 925, a correction component 930, a comparison component 935, an identification component 940, a gradient component 945, an interpolation component 950, and a weighting component 955. Each of these modules may communicate, directly or indirectly, with one another (e.g., via one or more buses).

The image data component 910 may capture image data based on a CFA associated with an image sensor, the image data including a set of pixels. The pattern component 915 may determine a CFA pattern of the CFA associated with the image sensor. The configuration component 920 may select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel. In some cases, the configuration includes a second indication of a set of phase detection pixels in the CFA pattern.

The determination component 925 may determine that the pixel of the set of pixels is defective using the configuration. In some examples, the determination component 925 may determine that a set of phase detection pixels of the set of pixels in the CFA pattern are defective pixels based on the image sensor. In some examples, the determination component 925 may determine a first pixel value of the pixel of the set of pixels. In some examples, the determination component 925 may determine a second pixel value of each pixel of the first set of neighboring pixels. In some examples, determining that the pixel of the set of pixels is defective may be based on the comparing. In some examples, the determination component 925 may determine that the pixel value of the pixel of the set of pixels is greater than the maximum pixel value of the first set of neighboring pixels by a threshold pixel value, where the threshold pixel value is configurable based on a set of tuning parameters including a weighting factor, the maximum pixel value, or a pixel offset value, or a combination thereof. In some examples, the determination component 925 may determine that the pixel value of the pixel of the set of pixels is less than the minimum pixel value of the first set of neighboring pixels by a threshold pixel value, where the threshold pixel value is configurable based on a set of tuning parameters including a weighting factor, the minimum pixel value, or a pixel offset value, or a combination thereof. In some cases, the pixel of the set of pixels is a center pixel in the first set of neighboring pixels. In some cases, the defective pixel includes a phase detection pixel.

The correction component 930 may correct the defective pixel using pixel values of the first set of neighboring pixels, or pixel values of the second set of neighboring pixels, or both. In some examples, the correction component 930 may correct the set of phase detection pixels of the set of pixels using pixel values of the first set of neighboring pixels or pixel values of the second set of neighboring pixels, or both. In some examples, the correction component 930 may clamp the pixel value of the pixel of the set of pixels with the maximum pixel value. In some examples, correcting the defective pixel may be based on replacing the pixel value of the pixel of the set of pixels with the maximum pixel value. In some examples, the correction component 930 may clamp the pixel value of the pixel of the set of pixels with the minimum pixel value. In some examples, correcting the defective pixel may be based on replacing the pixel value of the pixel of the set of pixels with the minimum pixel value. In some examples, correcting the defective pixel may be based on multiple color gradients. In some examples, correcting the defective pixel may be based on the weighting pixel value of each pixel of the second set of neighboring pixels along the first interpolation direction, or the weighting pixel value of each pixel of the second set of neighboring pixels along the second interpolation direction, or both. The comparison component 935 may compare the first pixel value to the second pixel value.

The identification component 940 may identify a maximum pixel value of the first set of neighboring pixels based on the pixel value of each pixel of the first set of neighboring pixels. In some examples, the identification component 940 may identify a minimum pixel value of the first set of neighboring pixels based on the pixel value of each pixel of the first set of neighboring pixels. The gradient component 945 may determine multiple color gradients based on a kernel, where the kernel includes the pixel and the second set of neighboring pixels, where each color gradient of the multiple color gradients characterizes a color variation along a different direction. The interpolation component 950 may determine a first interpolation direction based on determining a first color gradient along a first direction and a second color gradient along a second direction. In some examples, the interpolation component 950 may determine a second interpolation direction based on determining a third color gradient along a third direction and a fourth color gradient along a fourth direction.

The weighting component 955 may determine a direction weight based on the first color gradient, the second color gradient, the third color gradient, the fourth color gradient, or a combination thereof. In some examples, the weighting component 955 may determine a weighting pixel value of each pixel of the second set of neighboring pixels along the first interpolation direction. In some examples, the weighting component 955 may determine a weighting pixel value of each pixel of the second set of neighboring pixels along the second interpolation direction. In some examples, the weighting component 955 may apply, to the defective pixel, a weighted sum of the weighting pixel value of each pixel of the second set of neighboring pixels along the first interpolation direction or a weighted sum of the weighting pixel value of each pixel of the second set of neighboring pixels along the second interpolation direction based on the direction weight.

In some cases, the weighting pixel value of each pixel of the second set of neighboring pixels along the first interpolation direction or the weighting pixel value of each pixel of the second set of neighboring pixels along the second interpolation direction, or both are based on a preconfigured weighting pixel table. In some cases, the weighting pixel value of a pixel of the second set of neighboring pixels along the first interpolation direction, or the second interpolation direction, or both are zero based on the pixel being a phase detection pixel. In some cases, the weighting pixel value of a pixel of the second set of neighboring pixels along the first interpolation direction or the second interpolation direction, or both are non-zero based on the pixel being a non-phase detection pixel.

FIG. 10 shows a diagram of a system 1000 including a device 1005 that supports pattern configurable pixel correction in accordance with aspects of the present disclosure. The device 1005 may be an example of or include the components of device 705, device 805, or a device as described herein. The device 1005 may include components for bi-directional voice and data communications including components for transmitting and receiving communications, including a pattern configurable manager 1010, an I/O controller 1015, a transceiver 1020, an antenna 1025, memory 1030,a processor 1040, and sensor(s) 1045. These components may be in electronic communication via one or more buses (e.g., bus 1050).

The pattern configurable manager 1010 may capture image data based on a CFA associated with an image sensor, the image data including a set of pixels, determine a CFA pattern of the CFA associated with the image sensor, select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel, determine that the pixel of the set of pixels is defective using the configuration, and correct the defective pixel using pixel values of the first set of neighboring pixels, or pixel values of the second set of neighboring pixels, or both.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS, ANDROID, MS-DOS, MS-WINDOWS, OS/2, UNIX, LINUX, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas. In some cases, the device 1005 may include a single antenna 1025. However, in some cases the device 1005 may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The code 1035 may include instructions to implement aspects of the present disclosure, including instructions to support image processing. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting pattern configurable pixel correction).

The sensor(s) 1045 may be an example of an image sensor for capturing images. For example, sensor(s) 1045 may represent a camera operable to capture an image of a scene that may be processed by pattern configurable manager 1010 alone according to aspects of the present disclosure. In another example, sensor(s) 1045 may be an optical depth sensor (e.g., for determining or estimating a depth of an object or scene with respect to device 1005), a lux sensor (e.g., for detecting an illumination condition, luminance levels), a motion sensor (e.g., for detecting motion associated with the scene), an infrared heat sensor (e.g., for detecting humans and animals vs. objects in the scene), among others. Sensor(s) 1045 may, in some examples, be a charge coupled device (CCD) sensor or a complementary metal-oxide semiconductor (CMOS) sensor. The sensor(s) 1045 may utilize a single antenna or a set of antennas for transmitting and receiving information such as packets, user data, or control information associated with various information channels (e.g., control channels, data channels, and information related to pattern configurable pixel correction, etc.).

As detailed above, pattern configurable manager 1010 and/or one or more components of the pattern configurable manager 1010 may perform and/or be a means for performing, either alone or in combination with other elements, one or more operations for pattern configurable pixel correction.

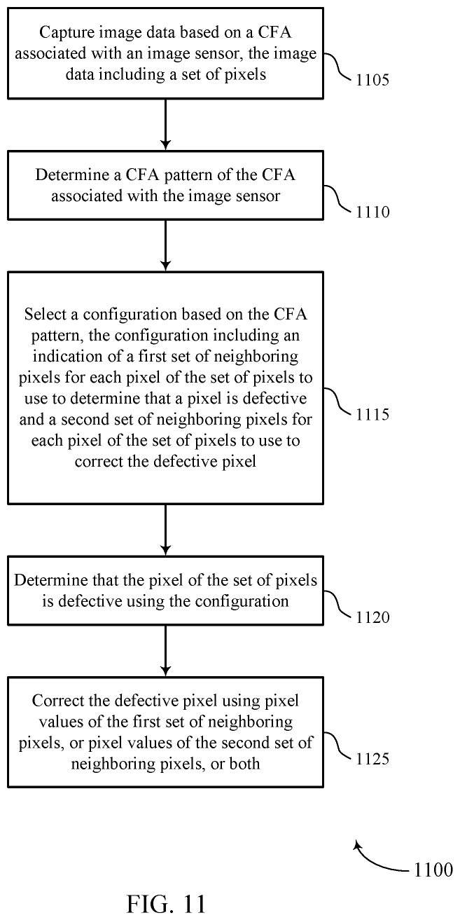

FIG. 11 shows a flowchart illustrating a method 1100 that supports pattern configurable pixel correction in accordance with aspects of the present disclosure. The operations of method 1100 may be implemented by a device or its components as described herein. For example, the operations of method 1100 may be performed by a pattern configurable manager as described with reference to FIGS. 7 through 10. In some examples, a device may execute a set of instructions to control the functional elements of the device to perform the functions described below. Additionally or alternatively, a device may perform aspects of the functions described below using special-purpose hardware.

At 1105, the device may capture image data based on a CFA associated with an image sensor, the image data including a set of pixels. The operations of 1105 may be performed according to the methods described herein. In some examples, aspects of the operations of 1105 may be performed by an image data component as described with reference to FIGS. 7 through 10.

At 1110, the device may determine a CFA pattern of the CFA associated with the image sensor. The operations of 1110 may be performed according to the methods described herein. In some examples, aspects of the operations of 1110 may be performed by a pattern component as described with reference to FIGS. 7 through 10.

At 1115, the device may select a configuration based on the CFA pattern, the configuration including an indication of a first set of neighboring pixels for each pixel of the set of pixels to use to determine that a pixel is defective and a second set of neighboring pixels for each pixel of the set of pixels to use to correct the defective pixel. The operations of 1115 may be performed according to the methods described herein. In some examples, aspects of the operations of 1115 may be performed by a configuration component as described with reference to FIGS. 7 through 10.

At 1120, the device may determine that the pixel of the set of pixels is defective using the configuration. The operations of 1120 may be performed according to the methods described herein. In some examples, aspects of the operations of 1120 may be performed by a determination component as described with reference to FIGS. 7 through 10.

At 1125, the device may correct the defective pixel using pixel values of the first set of neighboring pixels, or pixel values of the second set of neighboring pixels, or both. The operations of 1125 may be performed according to the methods described herein. In some examples, aspects of the operations of 1125 may be performed by a correction component as described with reference to FIGS. 7 through 10.

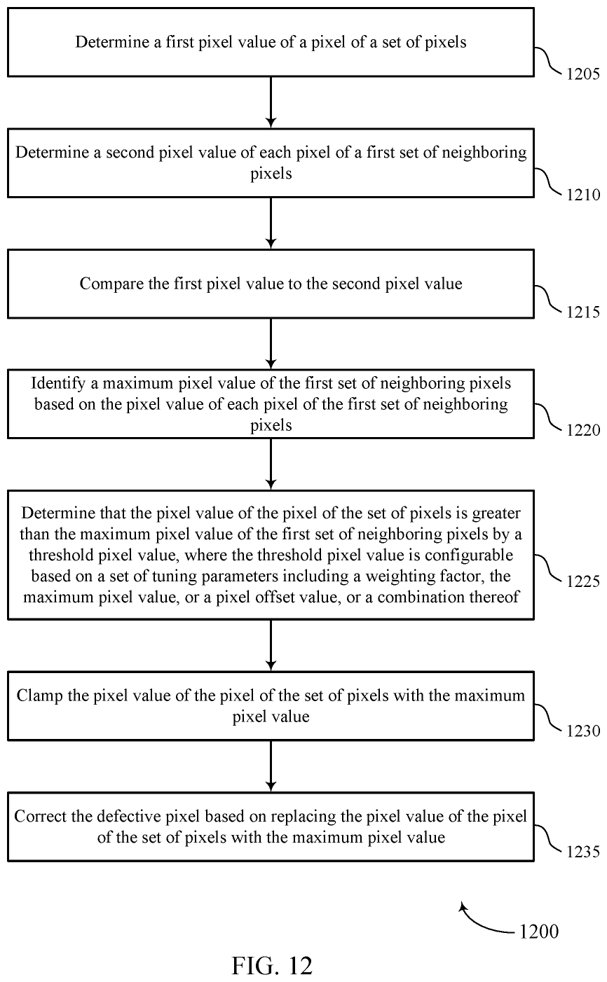

FIG. 12 shows a flowchart illustrating a method 1200 that supports pattern configurable pixel correction in accordance with aspects of the present disclosure. The operations of method 1200 may be implemented by a device or its components as described herein. For example, the operations of method 1200 may be performed by a pattern configurable manager as described with reference to FIGS. 7 through 10. In some examples, a device may execute a set of instructions to control the functional elements of the device to perform the functions described below. Additionally or alternatively, a device may perform aspects of the functions described below using special-purpose hardware.

At 1205, the device may determine a first pixel value of a pixel of a set of pixels. The operations of 1205 may be performed according to the methods described herein. In some examples, aspects of the operations of 1205 may be performed by a determination component as described with reference to FIGS. 7 through 10.

At 1210, the device may determine a second pixel value of each pixel of a first set of neighboring pixels. The operations of 1210 may be performed according to the methods described herein. In some examples, aspects of the operations of 1210 may be performed by a determination component as described with reference to FIGS. 7 through 10.

At 1215, the device may compare the first pixel value to the second pixel value. The operations of 1215 may be performed according to the methods described herein. In some examples, aspects of the operations of 1215 may be performed by a comparison component as described with reference to FIGS. 7 through 10.

At 1220, the device may identify a maximum pixel value of the first set of neighboring pixels based on the pixel value of each pixel of the first set of neighboring pixels. The operations of 1220 may be performed according to the methods described herein. In some examples, aspects of the operations of 1220 may be performed by an identification component as described with reference to FIGS. 7 through 10.

At 1225, the device may determine that the pixel value of the pixel of the set of pixels is greater than the maximum pixel value of the first set of neighboring pixels by a threshold pixel value, where the threshold pixel value is configurable based on a set of tuning parameters including a weighting factor, the maximum pixel value, or a pixel offset value, or a combination thereof. The operations of 1225 may be performed according to the methods described herein. In some examples, aspects of the operations of 1225 may be performed by a determination component as described with reference to FIGS. 7 through 10.

At 1230, the device may clamp the pixel value of the pixel of the set of pixels with the maximum pixel value. The operations of 1230 may be performed according to the methods described herein. In some examples, aspects of the operations of 1230 may be performed by a correction component as described with reference to FIGS. 7 through 10.

At 1235, the device may correct the defective pixel based on replacing the pixel value of the pixel of the set of pixels with the maximum pixel value. The operations of 1235 may be performed according to the methods described herein. In some examples, aspects of the operations of 1235 may be performed by a correction component as described with reference to FIGS. 7 through 10.

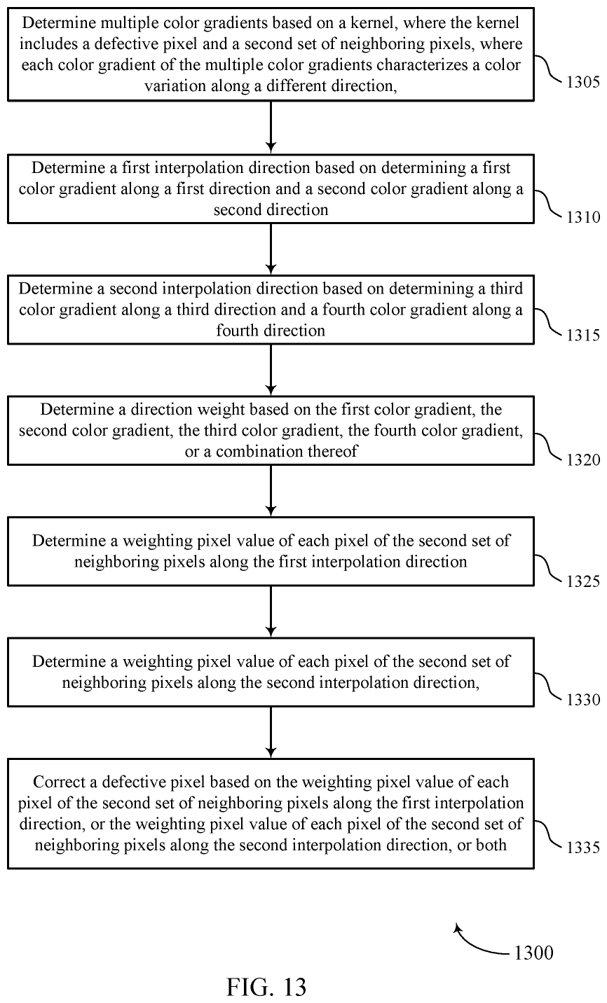

FIG. 13 shows a flowchart illustrating a method 1300 that supports pattern configurable pixel correction in accordance with aspects of the present disclosure. The operations of method 1300 may be implemented by a device or its components as described herein. For example, the operations of method 1300 may be performed by a pattern configurable manager as described with reference to FIGS. 7 through 10. In some examples, a device may execute a set of instructions to control the functional elements of the device to perform the functions described below. Additionally or alternatively, a device may perform aspects of the functions described below using special-purpose hardware.

At 1305, the device may determine multiple color gradients based on a kernel, where the kernel includes a defective pixel and a second set of neighboring pixels, where each color gradient of the multiple color gradients characterizes a color variation along a different direction. The operations of 1305 may be performed according to the methods described herein. In some examples, aspects of the operations of 1305 may be performed by a gradient component as described with reference to FIGS. 7 through 10.

At 1310, the device may determine a first interpolation direction based on determining a first color gradient along a first direction and a second color gradient along a second direction. The operations of 1310 may be performed according to the methods described herein. In some examples, aspects of the operations of 1310 may be performed by an interpolation component as described with reference to FIGS. 7 through 10.

At 1315, the device may determine a second interpolation direction based on determining a third color gradient along a third direction and a fourth color gradient along a fourth direction. The operations of 1315 may be performed according to the methods described herein. In some examples, aspects of the operations of 1315 may be performed by an interpolation component as described with reference to FIGS. 7 through 10.

At 1320, the device may determine a direction weight based on the first color gradient, the second color gradient, the third color gradient, the fourth color gradient, or a combination thereof. The operations of 1320 may be performed according to the methods described herein. In some examples, aspects of the operations of 1320 may be performed by a weighting component as described with reference to FIGS. 7 through 10.

At 1325, the device may determine a weighting pixel value of each pixel of the second set of neighboring pixels along the first interpolation direction. The operations of 1325 may be performed according to the methods described herein. In some examples, aspects of the operations of 1325 may be performed by a weighting component as described with reference to FIGS. 7 through 10.

At 1330, the device may determine a weighting pixel value of each pixel of the second set of neighboring pixels along the second interpolation direction. The operations of 1330 may be performed according to the methods described herein. In some examples, aspects of the operations of 1330 may be performed by a weighting component as described with reference to FIGS. 7 through 10.

At 1335, the device may correct the defective pixel based on the weighting pixel value of each pixel of the second set of neighboring pixels along the first interpolation direction, or the weighting pixel value of each pixel of the second set of neighboring pixels along the second interpolation direction, or both. The operations of 1335 may be performed according to the methods described herein. In some examples, aspects of the operations of 1335 may be performed by a correction component as described with reference to FIGS. 7 through 10.

It should be noted that the methods described herein describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing, comprising:
capturing image data based at least in part on a color filter array associated with an image sensor, the image data comprising a set of pixels;
determining a color filter array pattern of the color filter array associated with the image sensor;
selecting a configuration based at least in part on the color filter array pattern, the configuration comprising an indication of a first set of neighboring pixels for each pixel of the set of pixels to use to determine that a pixel is defective and a second set of neighboring pixels for each pixel of the set of pixels to use to correct the defective pixel;
determining that the pixel of the set of pixels is defective using the configuration; and
correcting the defective pixel using pixel values of the first set of neighboring pixels, or pixel values of the second set of neighboring pixels, or both.

2. The method of claim 1, further comprising:
determining that a set of phase detection pixels of the set of pixels in the color filter array pattern are defective pixels based at least in part on the image sensor; and
correcting the set of phase detection pixels of the set of pixels using pixel values of the first set of neighboring pixels or pixel values of the second set of neighboring pixels, or both.

3. The method of claim 1, further comprising:
determining a first pixel value of the pixel of the set of pixels;
determining a second pixel value of each pixel of the first set of neighboring pixels; and
comparing the first pixel value to the second pixel value,
wherein determining that the pixel of the set of pixels is defective is based at least in part on the comparing.

4. The method of claim 3, wherein the pixel of the set of pixels is a center pixel in the first set of neighboring pixels.

5. The method of claim 3, further comprising:
identifying a maximum pixel value of the first set of neighboring pixels based at least in part on the pixel value of each pixel of the first set of neighboring pixels;
determining that the pixel value of the pixel of the set of pixels is greater than the maximum pixel value of the first set of neighboring pixels by a threshold pixel value, wherein the threshold pixel value is configurable based at least in part on a set of tuning parameters comprising a weighting factor, the maximum pixel value, or a pixel offset value, or a combination thereof; and
clamping the pixel value of the pixel of the set of pixels with the maximum pixel value,
wherein correcting the defective pixel is based at least in part on replacing the pixel value of the pixel of the set of pixels with the maximum pixel value.

6. The method of claim 3, further comprising:
identifying a minimum pixel value of the first set of neighboring pixels based at least in part on the pixel value of each pixel of the first set of neighboring pixels;
determining that the pixel value of the pixel of the set of pixels is less than the minimum pixel value of the first set of neighboring pixels by a threshold pixel value, wherein the threshold pixel value is configurable based at least in part on a set of tuning parameters comprising a weighting factor, the minimum pixel value, or a pixel offset value, or a combination thereof; and
clamping the pixel value of the pixel of the set of pixels with the minimum pixel value,
wherein correcting the defective pixel is based at least in part on replacing the pixel value of the pixel of the set of pixels with the minimum pixel value.

7. The method of claim 1, further comprising:
determining multiple color gradients based at least in part on a kernel, wherein the kernel comprises the pixel and the second set of neighboring pixels, wherein each color gradient of the multiple color gradients characterizes a color variation along a different direction,
wherein correcting the defective pixel is based at least in part on the multiple color gradients.

8. The method of claim 7, further comprising:
determining a first interpolation direction based at least in part on determining a first color gradient along a first direction and a second color gradient along a second direction;
determining a second interpolation direction based at least in part on determining a third color gradient along a third direction and a fourth color gradient along a fourth direction; and
determining a direction weight based at least in part on the first color gradient, the second color gradient, the third color gradient, the fourth color gradient, or a combination thereof.

9. The method of claim 8, further comprising:
determining a weighting pixel value of each pixel of the second set of neighboring pixels along the first interpolation direction; and
determining a weighting pixel value of each pixel of the second set of neighboring pixels along the second interpolation direction,
wherein correcting the defective pixel is based at least in part on the weighting pixel value of each pixel of the second set of neighboring pixels along the first interpolation direction, or the weighting pixel value of each pixel of the second set of neighboring pixels along the second interpolation direction, or both.

10. The method of claim 9, wherein the weighting pixel value of each pixel of the second set of neighboring pixels along the first interpolation direction or the weighting pixel value of each pixel of the second set of neighboring pixels along the second interpolation direction, or both are based at least in part on a preconfigured weighting pixel table.

11. The method of claim 9, further comprising:
applying, to the defective pixel, a weighted sum of the weighting pixel value of each pixel of the second set of neighboring pixels along the first interpolation direction or a weighted sum of the weighting pixel value of each pixel of the second set of neighboring pixels along the second interpolation direction based at least in part on the direction weight.

12. The method of claim 9, wherein the weighting pixel value of a pixel of the second set of neighboring pixels along the first interpolation direction, or the second interpolation direction, or both are zero based at least in part on the pixel being a phase detection pixel.

13. The method of claim 9, wherein the weighting pixel value of a pixel of the second set of neighboring pixels along the first interpolation direction or the second interpolation direction, or both are non-zero based at least in part on the pixel being a non-phase detection pixel.

14. The method of claim 1, wherein the defective pixel comprises a phase detection pixel.

15. The method of claim 1, wherein the configuration comprises a second indication of a set of phase detection pixels in the color filter array pattern.

16. An apparatus for image processing, comprising:
a processor,
memory in electronic communication with the processor; and
instructions stored in the memory and executable by the processor to cause the apparatus to:
capture image data based at least in part on a color filter array associated with an image sensor, the image data comprising a set of pixels;
determine a color filter array pattern of the color filter array associated with the image sensor;
select a configuration based at least in part on the color filter array pattern, the configuration comprising an indication of a first set of neighboring pixels for each pixel of the set of pixels to use to determine that a pixel is defective and a second set of neighboring pixels for each pixel of the set of pixels to use to correct the defective pixel;
determine that the pixel of the set of pixels is defective using the configuration; and
correct the defective pixel using pixel values of the first set of neighboring pixels, or pixel values of the second set of neighboring pixels, or both.

17. The apparatus of claim 16, wherein the instructions are further executable by the processor to cause the apparatus to:
determine that a set of phase detection pixels of the set of pixels in the color filter array pattern are defective pixels based at least in part on the image sensor; and
correct the set of phase detection pixels of the set of pixels using pixel values of the first set of neighboring pixels or pixel values of the second set of neighboring pixels, or both.

18. The apparatus of claim 16, wherein the instructions are further executable by the processor to cause the apparatus to:
determine a first pixel value of the pixel of the set of pixels;
determine a second pixel value of each pixel of the first set of neighboring pixels; and
compare the first pixel value to the second pixel value,
wherein determining that the pixel of the set of pixels is defective is based at least in part on the comparing.

19. The apparatus of claim 18, wherein the pixel of the set of pixels is a center pixel in the first set of neighboring pixels.

20. An apparatus for image processing, comprising:
means for capturing image data based at least in part on a color filter array associated with an image sensor, the image data comprising a set of pixels;
means for determining a color filter array pattern of the color filter array associated with the image sensor;
means for selecting a configuration based at least in part on the color filter array pattern, the configuration comprising an indication of a first set of neighboring pixels for each pixel of the set of pixels to use to determine that a pixel is defective and a second set of neighboring pixels for each pixel of the set of pixels to use to correct the defective pixel;
means for determining that the pixel of the set of pixels is defective using the configuration; and
means for correcting the defective pixel using pixel values of the first set of neighboring pixels, or pixel values of the second set of neighboring pixels, or both.
